(19) United States
(12) Patent Application Publication
(10) Pub. No.: US 2015/0254217 A1
(43) Pub. Date: Sep. 10, 2015

(54) METHOD AND BROWSER FOR DISPLAYING OVERLAID WEBPAGES

(71) Applicant: YANDEX EUROPE AG, Luzern (CH)

(72) Inventor: Konstantin Pavlovitch Gorskiy, Moscow (RU)

(21) Appl. No.: 14/433,028

(22) PCT Filed: Oct. 1, 2013
(86) PCT No.: PCT/US13/62790

§ 371 Date: Apr. 1, 2015

(30) Foreign Application Priority Data
Oct. 1, 2012 (RU) PCT/RU2012/000799
Apr. 1, 2013 (RU) 2013115565

(51) Int. Cl. G06F 17/22; G06F 17/21

(52) U.S. Cl. CPC G06F 17/2235; G06F 17/2247; G06F 17/212

(57) ABSTRACT

The present invention relates to a computer-implemented method for displaying webpages. The method displays a first webpage in a browser of an electronic device, the first webpage having at least one hyperlink The method further receives selection of one of the at least one hyperlink of the first webpage by a user of the electronic device. The method then concurrently displays in the browser the first web page and a second webpage corresponding to a selected hyperlink, the second webpage being partially overlaid over the first webpage. In another aspect, the present invention relates to a computer program product which comprises a browser for interacting between a electronic device and a network. The browser comprises a display module for concurrently displaying a plurality of webpages in the browser, the plurality of webpages being partially overlaid.

### CROSS-REFERENCE

The present application claims convention priority to (1) International Application No. PCT/RU2012/000799, filed Oct. 1, 2012, entitled “Method and Browser for Displaying Overlaid Webpages” and to (2) Russian Patent Application No. 2013115565, filed Apr. 1, 2013, entitled “Method and Browser for Displaying Overlaid Webpages”. These applications are incorporated by reference herein in their entirety. The following applications are also incorporated by reference herein in their entirety: (1) International Application No. PCT/RU2012/000801, filed Oct. 1, 2012, entitled “Methods, Systems And Programs For Retrieving Information On The Internet”; (2) International Application No. PCT/RU2012/000800, filed Oct. 1, 2012, entitled “Method and System for Navigating to a Sub-Resource of an Internet Resource”; (3) International Patent Application No. PCT/RU2012/000798, filed Oct. 1, 2012, entitled “Method of and System for Providing Information to a User of a Client Device”; (4) Russian Patent Application No. 2013115564, filed Apr. 1, 2013, entitled “Methods, Systems And Programs For Retrieving Information On The Internet”; (5) Russian Patent Application No. 2013115566, filed Apr. 1, 2013, entitled “Method and System for Navigating to a Sub-Resource of an Internet Resource”; and (6) Russian Patent Application No. 2013115567, filed Apr. 1, 2013, entitled “Method of and System for Providing Information to a User of a Client Device”.

### FIELD

The present specification relates a computer-implemented method for displaying overlaid webpages and to a computer program product comprising a browser.

### BACKGROUND

Network browsers are used to access webpages in intranets and extranets (such as the Internet). The network browser typically displays a first page, such as a search page, in which a user of the network browser may enter a search query. Results of the search query are shown on a results page, which provides search results along with a hyperlink for each search result. Upon selection of one of the hyperlinks, the network browser either replaces the results page to display a webpage corresponding to the selected hyperlink, or alternatively opens a new tab on the network browser so as to display the webpage corresponding to the selected hyperlink on the new tab.

Typically, a user will select several hyperlinks during one network browsing session, which will result in a plurality of opened tabs, and a series of displayed webpages. However, prior art display methods of webpages from selected hyperlinks is not user-friendly, not visual, and often requires consulting a history of visited webpages to return to previously displayed webpages.

Further improvements to conventional browser for displaying webpages from selected hyperlinks are therefore desirable.

### SUMMARY

It is an object of the technology disclosed in the present specification to ameliorate at least some of the inconveniences present in the prior art.

It is a further object of the technology disclosed in the present specification to provide a computer-implemented method for displaying webpages. The method comprises displaying a first webpage in a browser of an electronic device, the first webpage having at least one hyperlink. The method also comprises receiving a selection of one of the at least one hyperlink of the first webpage by a user of the electronic device. Then, the method concurrently displays in the browser of the electronic device the first web page and a second webpage corresponding to a selected hyperlink, the second webpage being partially overlaid over the first webpage.

In another particular aspect, the present method further receives a selection of the first webpage by the user, and displays the first webpage partially overlaid over the second webpage.

In yet another aspect, the method further receives a selection of the first webpage by the user, and removes the second webpage from the browser.

In another aspect of the present method, the first webpage is displayed in a tab of the browser.

In yet another aspect of the present method, the second webpage is further displayed partially overlaid in the tab of the browser.

In still another particular aspect of the present method, the second webpage includes at least one hyperlink, and the method further comprises receiving a selection of one of the at least one hyperlink of the second webpage by the user of the electronic device, and concurrently displaying in the browser the first web page, the second webpage and a third webpage corresponding to a selected hyperlink of the second webpage, the second webpage being partially overlaid over the first webpage and the third webpage being partially overlaid over the second webpage.

In another aspect of the present method, the second webpage includes at least one hyperlink, and the method further comprises receiving selection of one of the at least one hyperlink of the second webpage by the user of the electronic device, and removing the first webpage from the browser.

In still another aspect, the method further comprises displaying a Uniform Resource Locator of the first webpage and a Uniform Resource Locator of the second webpage.

In a particular aspect of the present method, the second webpage overlays at least 75% of the first webpage.

In still another aspect, the present specification relates to a computer program product deliverable via computer-readable media such as storage media and communication links. The computer program product comprises a browser for interacting between an electronic device and a network. The browser comprises a display module for concurrently displaying a plurality of webpages in the browser, the plurality of webpages being partially overlaid.

In another aspect of the present computer program product, the display module displays the plurality of webpages in a tab of the browser.

In yet another aspect of the present computer program product, the display module further displays the plurality of webpages in chronological order of selection with a last selected webpage displayed overlaid over a previously selected webpage.

In another particular aspect of the present computer program product, the display module displays the plurality of webpages in reverse chronological order of selection.

In still another aspect of the present computer program product, the display module further reorders the plurality of webpage in such a manner as to display a last selected webpage overlaid over a previously selected webpage.

In yet another aspect of the present computer program product, the display module further removes from display an overlaid webpage upon selection of an underlaid webpage.

In a particular aspect of the present computer program product, at least 75% of an underlaid webpage is covered by an overlaid webpage.

In another aspect of the present computer program product, the overlaid webpage includes at least one hyperlink, and the display module further removes from display an underlaid webpage upon selection of the at least one hyperlink of the overlaid webpage.

In yet another aspect of the present computer program, the display module further displays the first webpage partially overlaid over the second webpage upon receipt of a selection of the first webpage by the user of the electronic device.

In still another aspect of the present computer program, the display module further removes the second webpage from the browser upon receipt of a selection of the first webpage by the user of the electronic device.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments and aspects of the present technology will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a non-limiting embodiment of a browser displaying webpages in accordance with aspects of the present method and computer program;

FIG. 2 is a schematic representation of the present computer program executed on electronic devices;

FIG. 3 is a flowchart of an aspect of the present method; and

FIG. 4 is a flowchart of another aspect of the present method.

### DETAILED DESCRIPTION

The present technology relates to a computer-implemented method and a computer program product for displaying overlaid webpages in a browser of an electronic device. Examples of electronic devices on which the present method and computer program product may be executed include computers, laptops, tablets, Personal Digital Assistants, smartphones, and any other electronic devices providing network browsing capabilities. More particularly, the present method and computer program concurrently display first and second webpages in a browser, the second webpage being partially overlaid over the first webpage.

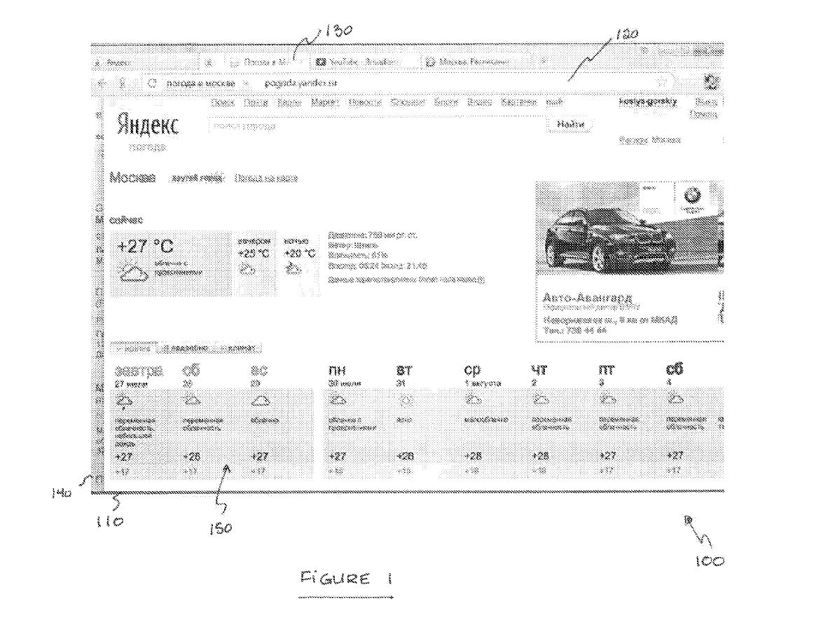

Reference is now made to FIG. 1, which depicts a non-limiting embodiment of a browser 100, the browser 100 displaying webpages in accordance with aspects of the present method and computer program. The browser 100 comprises a browser display window 110, and a Uniform Resource Locator (URL) display area 120. The browser 100 may further comprise one or several tabs 130. Further displayed in FIG. 1, as an example, is a first webpage 140 and a second webpage 150. The second webpage 150 is overlaid over the first webpage 140 in the browser display window 110. The second webpage 150 is overlaid directly within the browser display window 110 where the first webpage 140 is displayed. Thus the first webpage 140 and the second webpage 150 are concurrently displayed in the browser display window 110 of the browser 100, in such a manner that the second webpage 150 overlays over an area of the first webpage 140, without completely covering the first webpage 140. In a particular aspect, the second web page 150 may cover at least 75% of an area defined by the first webpage 140. Although only two webpages 140 and 150 are shown on FIG. 1, the present method and computer program are not limited to such an implementation, as more webpages (not depicted in FIG. 1) could alternatively be sequentially partially overlaid. Those skilled in the art will further recognize that the present browser 100 may comprise additional functionalities well known in the art, non-limitative examples of such additional functionalities including a ‘back button’ for allowing a user of the browser to display a previous webpage consulted, a ‘favorite button’ for allowing quick access to one or several favourite webpages, and a ‘stop button’ to end a download of a webpage.

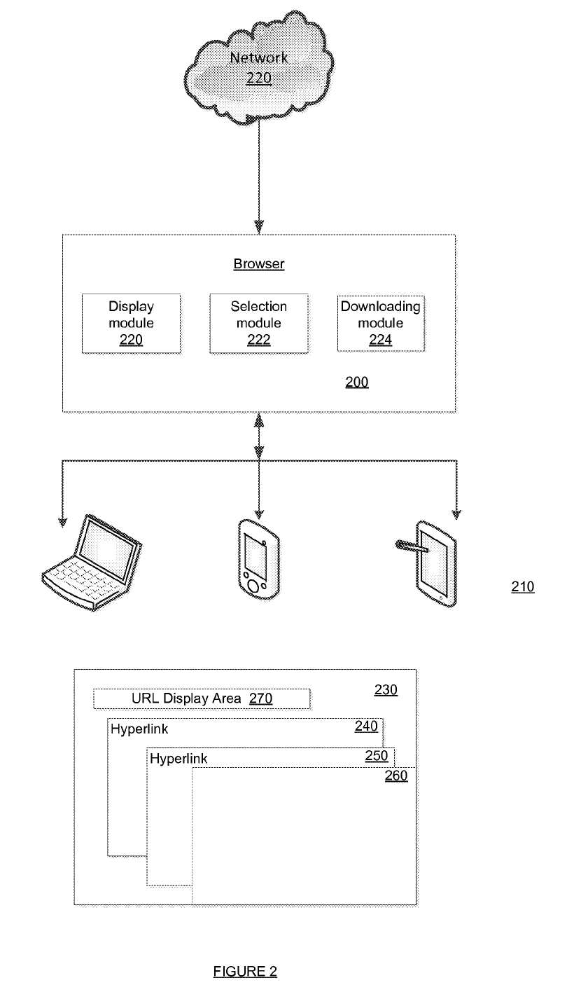

Reference is now concurrently made to FIGS. 1 and 2, where FIG. 2 is a schematic representation of a browser 200 of the present computer program executed on various types of electronic devices. The present computer program and/or browser may be delivered via computer-readable media, such as storage media, and/or communication links, such as Internet, an intranet or an extranet, to the electronic devices 210. The electronic devices 210 shown on FIG. 2 are for illustration purposes, to depict various types of electronic devices on which the present browser 200 can be stored in memory, installed and executed by a processor of the electronic device.

The present computer program product comprises the browser 200, which when installed and executed on an electronic device 210, allows a user of the electronic device interaction between the electronic device 210 and a network 220. The network 220 could for example include an intranet, an extranet, a public network, a private network, internet, etc., through any known wired and wireless communications means. The browser 200 comprises a display module 220 for displaying webpages corresponding to user selected hyperlinks, a selection module 222 for receiving a hyperlink or webpage selection from a user of the electronic device, and a downloading module 224 for downloading from the network 220 a webpage corresponding to a selected hyperlink. The downloading module 224 stores in memory (not shown), i.e. cache memory of the electronic device, a data representative of last downloaded webpage(s). Typically, the cache memory of the electronic device keeps in memory images and embedded hyperlinks of a certain number of previously downloaded webpages.

The webpages may be displayed directly in a display window, or in a tab of the display window. Most webpages include embedded therein hyperlinks, linking the webpage to one or several other webpages directly or indirectly (redirected). The present browser 200 thus provides a visually intuitive graphical representation of consecutively selected and accessed webpages. By concurrently displaying a plurality of consecutively selected and downloaded webpages 240, 250, 260 as partially overlaid images in a browser display 230, the present browser provides a visual history of selected and downloaded webpages. Although three webpages are shown on FIG. 2, the present browser is not limited to such a number of webpages, and as such the display module 220 could display two or more consecutively accessed webpages as partially overlaid images. The plurality of partially overlaid webpages 240, 250 and 260 may be displayed in a tab of the browser display, as shown on FIG. 1, or in a window of a browser display 230 as shown on FIG. 2.

The display module 220 may overlay the webpages in the browser in various ways. In a particular aspect, the plurality of partially overlaid webpages 240, 250 and 260 may be displayed in chronological order of accession or selection, with a last accessed/selected webpage displayed overlaid over a previously accessed/selected webpage. In another particular aspect, the plurality of webpages may be displayed in reverse chronological order of selection. In yet another particular aspect, which may be combined with previous aspects or implemented separately as a standard or as a user preference, the display module 220 may reorder the plurality of webpages in such a manner so as to display a last selected webpage overlaid over a previously selected webpage. In still another particular aspect, which may also be combined with previous aspects or implemented separately as a standard or as a user preference, the display module may further remove from the browser display 230 an overlaid webpage upon selection by a user of the electronic device of an underlaid webpage.

To prevent overlaying of an excessive number of webpages in the browser display 230, the browser 200 may further handle user selections and actions on displayed webpages or in the URL display area 270 as a request to perform one or several of the following: stop overlaying displayed webpages, remove one or several undermost displayed webpages, remove specific overlaid or underlaid displayed webpages, open a new tab to displace and display a group of the undermost displayed webpages, or any other mechanism to keep a number of overlaid webpages visually representative and useful.

Display of the accessed/selected webpages as partially overlaid webpages in the browser may include further functionalities, which may be standardized by a provider or manufacturer of the computer product, or customized by the user of the computer product. For example, the user may determine a number of webpages, which may be consecutively overlaid before the undermost webpage is removed from the display. A user may further select a minimum and/or maximum coverage area for overlaying a subsequently accessed webpage, for example a minimum of 75% and a maximum 85%, so that underlaid webpages are still shown with sufficient graphical information so as to be visually recognizable from overlaid web pages. A user may also activate and/or deactivate functions such as reordering of webpages upon selection of an underlaid webpage, removal of overlaid webpage upon selection of an underlaid webpage, removal of underlaid webpage upon selection of a new hyperlink on the overlaying webpage, etc.

The present displaying of overlaid webpages in a single browser window, or tab, provides a visual graphical representation of selected and downloaded webpages, which translates into a visually enriched network browsing experience for users. By consecutively overlaying selected and downloaded webpages in one window or tab, a user may see at-a-glance previously selected and downloaded webpages. In addition, it remains possible to go back to a previously downloaded webpage by selecting that underlaid webpage, instead of having to use the prior art functionality of a ‘back button’. Selecting an underlaid webpage automatically brings that underlaid webpage over the other webpages, while keeping the embedded hyperlinks active in that selected webpage. The user of the present browser sees a portion of the underlaid webpages in the browser, which renders accessing previously viewed webpages more intuitive. As downloaded webpages are stored in memory, there is no need for reloading a previously downloaded webpage, only to select it as to bring it over the other webpages. Furthermore, by overlaying previously selected and downloaded webpages, a user's navigation is visually enhanced, rendered more intuitive and efficient.

Additionally, the present display method provides a navigation graphical history which memorizes and displays which hyperlink(s) has/have been selected and later displayed on one webpage. For example, if a user searched using the present browser for “blue car”, found results, clicked on them and navigated away, the user can return to the results of “blue car” and select another path or navigate away from the results page. Because downloaded webpages are stored in memory of the electronic device and displayed in the browser as overlaid webpages, a navigation history is visually depicted for the user, which facilitates and speeds up navigation. Furthermore, when the user selects an underlaid webpage, the browser displays the underlaid page over the other webpages as it was stored in memory, thus reducing refreshing of previously downloaded webpages. Refreshing of an underlaid webpage is performed only when the user performs a selection in a selected underlaid webpage, or updated in the background in the case of a dynamic webpage, such as a news webpage or Facebook™ or Twitter™ webpages.

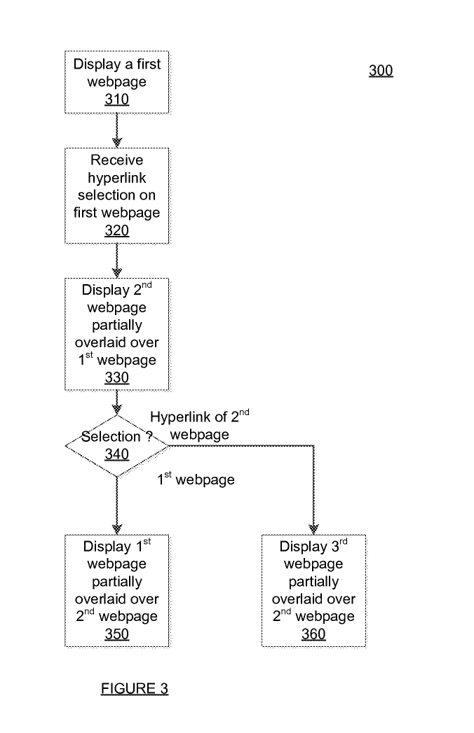

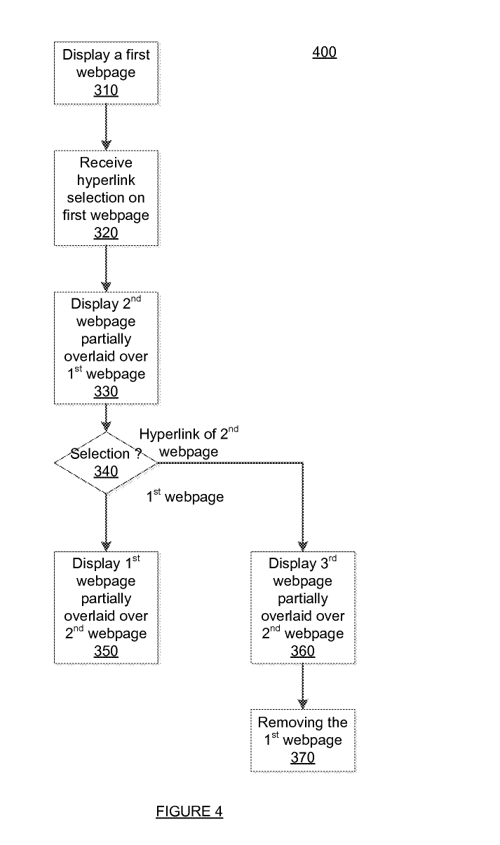

Reference is now made concurrently to FIGS. 2-4, where FIGS. 3 and 4, which are exemplary flow charts of two aspects of the present computer-implemented method for displaying consecutively accessed or selected webpages as partially overlaid webpage images in a browser display 230. The method 300 starts with displaying 310 a first webpage 240 in the browser display 230, either in directly in a display window or in a tab. The first webpage 240 comprises at least one hyperlink, each hyperlink providing a corresponding network address accessible by the browser 200 upon selection by a user of the electronic device. The method pursues with receiving 320 at the selection module 222 of the browser 200 a selection of one of the at least one hyperlink of the first webpage by the user of the electronic device. If the webpage corresponding to the selected hyperlink is not already in memory, the downloading module 224 of the browser requests and downloads the corresponding webpage from the network 220, as is well known in the art. The method continues with concurrently displaying 330 in the browser display 230 of the electronic device the first web page 240 and a second webpage 250 corresponding to the selected hyperlink, the second webpage 250 being partially overlaid over the first webpage 240. The second webpage 250 may further comprise at least one hyperlink, which may be selected by the user.

The method then continues when a user of the electronic device performs another selection 340. If the user selects to revert to the first webpage, the present browser reorders the overlaid webpages to display 350 the first webpage partially overlaid over the second webpage, i.e. reorders a last selected webpage on top of the overlaid webpages. If the user selects a hyperlink from the second webpage, the browser displays 360 a third webpage corresponding to the hyperlink selected from the second webpage, partially overlaid over the second webpage. Thus the present method displays multiple partially overlaid webpages in one single window or tab, in an order of selection. In a particular aspect of the present method shown on FIG. 4, the method further removes 370 the first webpage after having displayed the third webpage overlaid over the second webpage in 360. Additionally, the method may further display in a URL display the URL of the first webpage, the URL of the second webpage and the URL of the third webpage.

Modifications and improvements to the above-described embodiments of the present technology may become apparent to those skilled in the art. The foregoing description is intended to be exemplary rather than limiting. The scope of the present invention is therefore intended to be limited solely by the scope of the appended claims.

1. A computer-implemented method for displaying webpages, the method comprising:
displaying a first webpage in a browser of an electronic device, the first webpage having at least one hyperlink;
receiving selection of one of the at least one hyperlink of the first webpage by a user of the electronic device; and
concurrently displaying in the browser of the electronic device the first web page and a second webpage corresponding to a selected hyperlink, the second webpage being partially overlaid over the first webpage.

2. The computer-implemented method of claim 1, further comprising:
receiving selection of the first webpage by the user, and
displaying the first webpage partially overlaid over the second webpage.

3. The computer-implemented method of claim 1, further comprising:
receiving selection of the first webpage by the user; and
removing the second webpage from the browser.

4. The computer-implemented method of any one of claims 1 to 3, wherein the first webpage is displayed in a tab of the browser.

5. The computer-implemented method of claim 4, wherein the second webpage is further displayed partially overlaid in the tab of the browser.

6. The computer-implemented method of any one of claims 1 to 5, wherein:
the second webpage includes at least one hyperlink; and
wherein the computer-implemented method further comprises:
receiving selection of one of the at least one hyperlink of the second webpage by the user of the electronic device; and
concurrently displaying in the browser the first web page, the second webpage and a third webpage corresponding to a selected hyperlink of the second webpage, the second webpage being partially overlaid over the first webpage and the third webpage being partially overlaid over the second webpage.

7. The computer-implemented method of any one of claims 1 to 5, wherein:
the second webpage includes at least one hyperlink; and
wherein the computer-implemented method further comprises:
receiving selection of one of the at least one hyperlink of the second webpage by the user of the electronic device; and
removing the first webpage from the browser.

8. The computer-implemented method of any one of claims 1 to 7, wherein the method further comprises displaying a Uniform Resource Locator of the first webpage and a Uniform Resource Locator of the second webpage.

9. The computer-implemented method of any one of claims 1 to 8, wherein the second webpage overlays at least 75% of the first webpage.

10. A computer program product deliverable via computer-readable media such as storage media and communication links, said product comprising a browser for interacting between an electronic device and a network, the browser comprising:
a display module for concurrently displaying a plurality of webpages in the browser, the plurality of webpages being partially overlaid.

11. The computer program product of claim 10, wherein the display module displays the plurality of webpages in a tab of the browser.

12. The computer program product of any one of claims 10 to 11, wherein the display module further displays the plurality of webpages in chronological order of selection with a last selected webpage displayed overlaid over a previously selected webpage.

13. The computer program product of any one of claims 10 to 11, wherein the display module displays the plurality of webpages in reverse chronological order of selection.

14. The computer program product of any one of claims 10 to 13, wherein the display module further reorders the plurality of webpage in such a manner as to display a last selected webpage overlaid over a previously selected webpage.

15. The computer program product of any one of claims 10 to 14, wherein the display module further removes from display an overlaid webpage upon selection of an underlaid webpage.

16. The computer program product of any one of claims 10 to 15, wherein at least 75% of an underlaid webpage is covered by an overlaid webpage.

17. The computer program product of any one of claims 10 to 16, wherein:
the overlaid webpage includes at least one hyperlink; and
the display module further removes from display an underlaid webpage upon selection of the at least one hyperlink of the overlaid webpage.

18. The computer program of any one of claims 10 to 17, wherein the display module further displays the first webpage partially overlaid over the second webpage upon receipt of a selection of the first webpage by the user of the electronic device.

19. The computer program of any one of claims 10 to 18, wherein the display module further removes the second webpage from the browser upon receipt of a selection of the first webpage by the user of the electronic device.
